(19) United States
(12) Patent Application Publication
(10) Pub. No.: US 2023/0285796 A1
(43) Pub. Date: Sep. 14, 2023

(54) TISSUE CONFIGURATION PLATFORM

(71) Applicant: Rudy Alexander RIVERON, San Diego, CA (US)

(72) Inventor: Rudy Alexander RIVERON, San Diego, CA (US)

(21) Appl. No.: 18/040,567

(22) PCT Filed: Aug. 3, 2021
(86) PCT No.: PCT/US2021/044302

§ 371 Date: Feb. 3, 2023

Related U.S. Application Data
(60) Provisional application No. 63/060,473, filed on Aug. 3, 2020.

(51) Int. Cl. A63B 21/00; A61H 23/00

(52) U.S. Cl. CPC A63B 21/4033; A61H 23/006; A61H 2201/1604

(57) ABSTRACT

A system for tissue configuration includes a frame that comprises a planar surface comprising a platform defined by a left edge, a right edge, a head edge and a foot edge, and one or more covering attachments. Each covering attachment include a first region at which the covering attachment is coupled to the left edge and a second region of the covering attachment coupled to the right edge, further including a body portion that spans between the first region and the second region over the planar surface forming an opening between the body of the covering attachment and the planar surface. The body of at least some of the covering attachment includes a first side oriented towards the planar surface, the first side comprising one or more attachment points having one or more base units to which one or more extension attachments extending towards the planar surface are attachable.

### CROSS-REFERENCE TO RELATED APPLICATIONS

The present document claims the benefit of priority of U.S. Provisional Application 63/060,473, entitled “Tissue Configuration Platform,” filed on Aug. 3, 2020, incorporated herein by reference in its entirety.

### BACKGROUND

Currently, health professionals use a variety of equipment for physical therapy and related body tissue and muscle exercise regimen. Most of the present day equipment was designed many decades ago and tends to be bulky or non-versatile. With advent of medical and health sciences understanding of how human body works has improved over the last several decades.

### SUMMARY

This document discloses apparatus that may be used in various embodiments for therapeutic, diagnostic and research tools in health industry by providing ability to isolate a muscle or a muscle group of human body for checking or exercising.

In one example aspect, a platform is disclosed. The platform includes a frame that comprises a planar surface comprising a platform defined by a left edge, a right edge, a head edge and a foot edge, and one or more covering attachments, wherein each covering attachment include a first region at which the covering attachment is coupled to the left edge and a second region of the covering attachment coupled to the right edge, the covering attachment further including a body portion that spans between the first region and the second region over the planar surface forming an opening between the body of the covering attachment and the planar surface. The body of at least some of the covering attachment includes a first side oriented towards the planar surface, the first side comprising one or more attachment points having one or more base units to which one or more extension attachments extending towards the planar surface are attachable.

In yet another example aspect, a method of tissue manipulation is disclosed. The method includes attaching one or more covering attachments to a frame mounted upon a support structure, wherein the frame comprises a planar surface comprising a platform defined by a left edge, a right edge, a head edge and a foot edge, wherein each covering attachment include a first region at which the covering attachment is coupled to the left edge and a second region of the covering attachment coupled to the right edge, the covering attachment further including a body portion that spans between the first region and the second region over the planar surface forming an opening between the body of the covering attachment and the planar surface; wherein the body of at least some of the covering attachments includes a first side oriented towards the planar surface, the first side comprising one or more attachment points having one or more base units; attaching one or more extension attachments extending towards the planar surface such that a distal tip of the one or more extension attachments is in close contact with a target object on the planar surface; and controlling a linear and/or an angular position of the one or more covering attachment according to a therapy regimen.

In another example aspect, an arm fixture for a tissue manipulation apparatus is disclosed. The arm fixture includes an elongated body having a first end affixable to an attachment point and a second end to which a tissue interface is attachable, the elongated body comprising multiple segments coupled to each other through joints, and an extension-retraction lever coupled to a segment of the multiple segments, wherein the extension-retraction level includes a cam element located within a cam housing such that a rotational movement of the extension-retraction lever causes the cam element to rotate within the cam housing, thereby causing the segment to move along a direction, the extension-retraction level being lockable at various angles with respect to the segment.

These, and other, features are described in this document.

### DESCRIPTION OF THE DRAWINGS

Drawings described herein are used to provide a further understanding and constitute a part of this application. Example embodiments and illustrations thereof are used to explain the technology rather than limiting its scope.

FIG. 1A shows a 3D illustration of a platform (27) in a diagonal view with a human subject (31).

FIG. 1B shows a 3D illustration of the apparatus in a diagonal view highlighting the ring system's capacity to both rotate the ring a full 360 degrees in both directions and traverse the length of the table via slits (26) on both sides of the platform (27).

FIG. 2A shows a frontal view of the apparatus demonstrating the ring (21) through the slits of the platform (27).

FIG. 2B shows a frontal view of the apparatus with an alternate embodiment of the ring housing (30) with the ring (21) going only through the housing.

FIG. 3 shows two frontal views of the apparatus highlighting locking mechanisms of the ring system.

FIG. 4 shows a below view of the apparatus highlighting the railing system (34) for the ring housing (30).

FIG. 5 shows a lateral view of apparatus with multiple rings (21) and ring housing (30).

FIG. 6 shows multiple views of the rings (21) and shapes employed for said rings for various functions.

FIG. 7 shows two frontal views of a ring with both a fixed (40) and moveable attachment point (41), along with the capacity to reposition any fixture by turning the ring.

FIG. 8 shows multiple articulated arm fixture (22) types along with various functions of the fixtures.

FIG. 9 shows multiple components used in combination on a human subject (31), with a practitioner (47) controlling the apparatus.

FIG. 10 shows a front facing view with multiple arm fixtures (22) positioned in various ways.

FIG. 11A shows a lateral view of the apparatus with head/foot boards (49) to allow for additional fixtures.

FIG. 11B shows a lateral view of the entire apparatus with both head/foot board (49), the ring (21), and ring housing (30) that typify the ring system.

FIG. 12A shows a front and back view of the fixture board (49) with the ability to slide and reposition various fixtures placed upon it such as articulated arms (22).

FIG. 12B shows a lateral view of the platform (27) with an optional groove (50) to attach additional slidable fixtures.

FIG. 13A shows 3 frontal views of the apparatus featuring various support fixtures (51) such as bars and trays etc.

FIG. 13B shows two frontal views of a human subject (31) engaging in exercise via a support structure (51) affixed to the rotatable ring.

FIG. 14 shows a lateral view of the multiple simultaneous functions of the apparatus.

FIG. 15 shows a front view of additional simultaneous functions of the apparatus.

FIG. 16A shows a lateral view of a compound functionality of the apparatus including resistive exercising.

FIG. 16B shows a novel interaction with the platform (27) and ring (21) system through a novel positioning of the subject.

FIG. 17 shows a lateral view of the apparatus with an alternative use for the ring housing (30) such as securing and/or housing a strap.

FIG. 18 shows a lateral view of the apparatus with options for altering the direction of gravity on biological tissues (31).

FIG. 19 shows a lateral view of the apparatus in a vertical position allowing for additional novel configuring of biological tissues (31) in gravity.

FIG. 20 shows a frontal view of the apparatus in an environment suitable for various lighting and imaging systems (60) to be utilized for data collection.

FIG. 21 is a flowchart of an example method of using the apparatus.

FIG. 22 shows an example of an extension attachment having two joints.

FIG. 23 shows an example of a cam box mechanism with handle in unextended position.

FIG. 24 shows an example of a cam box mechanism with handle in extended position.

FIG. 25 shows an example of an extension attachment having two handles for simultaneous manipulation.

FIG. 26 shows another example of an extension attachment having two handles for simultaneous manipulation

FIG. 27 shows another example of an extension attachment having two handles for simultaneous manipulation

FIG. 28 shows another example of an extension attachment having two handles for simultaneous manipulation.

FIG. 29 is a side elevation view of a tissue manipulation apparatus.

FIGS. 30A-30B depict tilting aspects of a tissue manipulation apparatus.

### DETAILED DESCRIPTION

Various embodiments of an apparatus that can be used for tissue reconfiguration by healthcare professionals such as physical therapists, sports or exercise coaches, and so on. While the various embodiments and features are described by referring to “the apparatus” in the present document, it will be understood such a reference is not to a single design but an embodiment according to the described feature and therefore may not necessarily include other features described in the present document.

The present document concerns a modular reconfigurable platform with a moveable and lockable ring system that enables a method of producing desired biological tissue configurations and forces upon tissues, in a manner similar to what is traditionally performed by a manual therapist or fitness professional, with increasingly minimal effort. Biological tissues, typically a living human subject, may be placed upon the platform and be supported, deformed, and stretched by various positionable fixtures to create numerous configurations of tissues in any direction in 3D space, in any conceivable combination, while also providing the ability to contract and exercise tissues in these various configurations. The tissue configuration platform has been conceived as a noninvasive nonsurgical device capable of mechanically positioning and deforming tissues without cutting, rupturing, injuring, or damaging tissues in any way. Tissue configurations will be achievable through the primary mechanical forces of compression, tension, bending, torsion and shear, along with methods of traction, stretch, support, and positioning of tissues, to create any conceivable therapeutic configuration of tissues in 3D space, and allowing tissues and tissue segments to move in any direction relative to one another and themselves, in any combination.

Any external and internal arrangement of tissues to tolerable and safe levels may be achieved provided they are arrived at by only deformational forces that do not separate the tissues from their natural origins. The tissue configuration platform operates to greatly increase the amount of inputs a manual therapy intervention can employ at once, which has typically been limited in the field due to the limited nature of a single practitioner body. The apparatus in an example embodiment will through its various mechanical components, maintain a desired configuration of tissues, regardless of the practitioner's physical position and will not require direct contact by practitioners to sustain such inputs. The apparatus aims to allow practitioners to do more, interact with numerous tissue locations at once, avoid repetitive stress injuries from repeated force application, collect data, perform palpation, take notes, and focus on analysis of effects observed before, during, and after tissue configuring. Typical industry wide methods of performing tissue manipulation rely on the bracing of a practitioner's skeletal muscles for extended periods to sustain the desired force often resulting in work related injuries and early retirement from the profession. The force application aspects of the apparatus may prevent such injuries from occurring and may extend the career of a practitioner or professional. Furthermore, enhancements to manual therapy such as heat, ice, ultrasounds, light therapy and other non-human effects may be employed via the device without the need for practitioners to continually hold a handheld device or other machine. While the apparatus is intended to be utilized in conjunction with data collection technology, digital technology, artificial intelligence, and others, the apparatus itself is principally conceived in a preferred embodiment as a nonelectrical, analog, mechanical device. An aim of the apparatus to create conditions in which the effects of configuring and deforming of tissues both internally and externally can be easily captured and analyzed so that future configuring and manipulating of tissues can occur in an ever increasingly predictable manner. Utilization of 3D modeling software in conjunction with collection of known and unknown biometric data may serve to create repeatable and automatic tissue configuration technologies, and also allow for a highly definable and describable account of what was done. While some embodiments may be used for manual therapy and fitness applications, these embodiments may also serve some utility or function in medical, veterinary, laboratory, and/or other related fields.

Tissue manipulation for the purposes of pain reduction, relaxation, hydration, inflammation reduction, physical fitness and performance, and a myriad of other purposes have been utilized in a variety of ways for thousands of years. The concrete effects of such manipulations have been debated for years and continue to be debated particularly in the realms of pain science and histological research. Means of cataloging and collecting data about changes in tissues have been unsystematic and lacking in means to reproduce such manipulations precisely. Presently, a debate continues concerning pain reduction as it pertains to manual therapy interventions, specifically if changes in the pain experience of a subject is due to descending modulation of pain signals within the brain and nervous system, or if the change in pain can be attributed to effects from the mechanical manipulation of tissues themselves. A complexity that may be obfuscating better understanding of such effects may be how various tissues move and interact with one another in various states, qualities, shapes, disease states, anatomical expressions, positions etc. What may be needed is a framework for understanding histological dynamics, recording data related to these dynamics, and creating predictable models for tissue configuring that predictably reduce pain, enhance performance, or in some other way improve the quality of the tissues being configured.

Those familiar with the concept of neurodynamics will appreciate the complexity a single tissue can have as it pertains to its dynamics within the body. A single nerve may run all the way from the brain to the toes, and make its way around numerous joints, tissues, tunnels, foramen and pierce through muscles, connective tissue, skin etc. This leaves many possibilities for entrapment and creates various ways that forces may act upon it, particularly when compound or complex movement is performed by the human body. Age, hydration levels and a number of other factors may also alter these dynamics. As such, intentionally moving, deforming, or configuring specific tissues, may require the precise manipulation of various other tissues and body parts in combination simultaneously, in novel or unorthodox fashions. The combining of different joint angles and deformations may be the only means of effecting such a tissue in an intended and predictable manner and will likely require thorough anatomical knowledge from the practitioners as well as biometric data of all kinds, known and unknown. Getting a specific anatomical structure or section of an anatomical structure to move, deform, traction in a specific way relative to its surrounding structures and other distal structures, may require a thoroughly established and executable myriad of compound positionings, pressure applications, non-human effects, and other input to achieve said manipulation in close to or exactly the manner in which a therapist envisions or prefers. All manner of therapeutic manipulations may be deployed by a single operator alone. Human subjects (31) who have difficulty moving themselves or moving certain areas of their bodies due to injury, weakness, or other reason may benefit greatly from the versatility of the apparatus. Due to the often reactive nature of strained muscle and other contractile tissues it can be essential to provide adequate support for body parts so that the sensory information coming into the brain is adequate to stimulate relaxation rather than constrictive responses. The multivariable nature of potential set ups or rigs a practitioner can create, may allow for various session types to occur with minimal effort and movement of either the practitioners or subj ect.

In one example aspect, disclosed embodiments of the apparatus provide ways to create perhaps infinite nuanced combinations. Such combinations and data gathering about these combinations may lead to numerous discoveries about the transmission of force across biological tissues. The inventor proposes a histodynamic approach to the manipulation of tissues and proposes an apparatus for achieving both tissue configuring and histodynamic analysis.

Some embodiments of the apparatus may additionally offer another means to perform manual therapy interventions of all kinds, such as, but not limited to, trigger point, myofascial release, deep tissue, lymphatic drainage, active release, chiropractic adjustment, acupressure, muscle activation, prioceptive neuromuscular facilitation, orthopedic and medical massage, and any other method of manually manipulating and facilitating biological tissues.

One example implication of the disclosed technology is to shift arguments about elastic and plastic deformation of tissues towards more generalized discussion about deformation of tissues from a physics perspective as being the alteration of said tissues from a reference configuration to an alternate or current one. Tracking changes of tissues over time in a number of conditions, and how movement or deformation of tissues passively affect other connected areas, may provide further data for additional creative interventions. The apparatus will permit practitioners to conceive of and execute perhaps an infinite variety of interventions based on whatever therapeutic or fitness rationale they have. Primarily conceived as a manual therapy device with possibilities for stretching, moderate strength training, and muscle activation, the device may become capable of more challenging strength training provided the support rings are in a preferred embodiment created with ample structural capacity to withstand such demands.

Some embodiments may be especially useful for creating asymmetric variants of typical exercises, supports, or manipulations. When dealing with asymmetries of the body, either in terms of pain, posture, muscle tone, innervation, strength, structural inequalities and limb lengths, the system can provide customization to multiple body segments simultaneously.

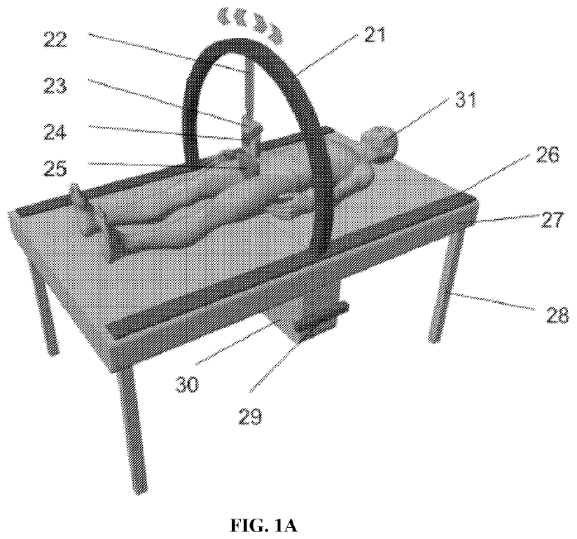

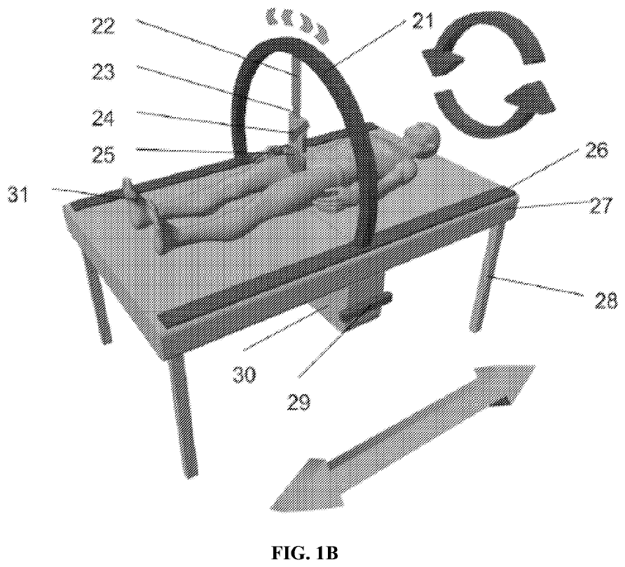

FIG. 1A is a 3D illustration of some embodiments; composed primarily of a Platform (27) with legs (28) designed to hold a subject containing biological tissues (31), typically a human subject/body. The Platform (27) in a preferred embodiment is flanked by two slits (26) that form a canal shaped aperture for the ring (21) to pass through. The track (26) provides a space for a Ring (21) to be connected to the platform (27) with the ring going through each slit. The Ring (21) in a preferred embodiment is able to rotate a full 360 degrees in the housing in either direction, though its full rotation may be limited when a fixture such as an Articulated Arm Fixture (22) is installed upon it. In general, the “ring” may be any covering structure that spans over the platform 27 such that an object, e.g., a human body can fit within the space created between the covering structure and the platform 27. The cross section of the covering structure may be circular, rectangular (or square) or of any other constant or variable shape. For example, a circular cross section like a hoola hoop ring may be helpful in angularly rotating a position of the covering structure, as is described herein. Alternatively, a rectangular cross section of the ring 21 may be useful in sturdy mechanical grasping and also for secure holding of arm fixtures described in the present document. In some embodiments, the size and shape of cross-section of the ring 21 may be different in different places—e.g., wider at the base where the ring 21 is coupled to the platform, and narrow in the portion spanning over the platform allowing for easy manipulation by a practitioner striking a balance between weight of the ring and sturdiness.

In some embodiments, the covering structure may be circular allowing for full 360 degree rotations. In some embodiments, the covering structure may be rectangular. This covering structure may be moveable laterally between headboard and baseboard but not rotatable. However, a flat portion on the top may allow attachments of multiple arm fixtures that are parallel to each other (e.g., counterweight for weight training).

In some embodiments, without any attachments or fixtures, the ring (21) that is circular will be able to make full 360 degree turns within the housing in either direction continuously. Other fixtures of any kind may be affixed to the ring (21) for a myriad of purposes, but the preferred embodiment typically contains at least one attachable/detachable articulated arm fixture (22). It should be noted that a fixture may take any form that serves a configuring function and may be referred to more generally as a treatment/configuring fixture (22). The Ring (21) surrounds the platform, goes through the slits and exists within a ring housing (30) that provides structure and support for the ring, as well as functionality such as, but not limited to, locking and unlocking the ring in various positions. The ring housing (30) may be equipped with a Ring Housing Handle (29) that may provide an ergonomic means to move the ring and its housing in a stabilized and smooth fashion along the length of the table as well as, provides means by which to engage and disengage any locks or effects. Ring housings (30) may in a preferred embodiment be wider than a ring to better enable a firm grip/contact to the structure of the platform (27) creating more structural stability. Any shaping or expression of ring housing (30) may be utilized as may be necessary to accommodate any structural support necessary for the platform (27). Dimensions of all components can be customized to best suit the size of the subjects and practitioners utilizing the apparatus. The platform (27) may be outfitted with any equipment that provides a desirable level of comfort for subjects placed upon it. FIG. 1A additionally shows the Ring (21) with an articulated arm fixture (22) which is within arm's reach of an operator or practitioner. Through the connection of the articulated arm and ring, a tissue interface (25) is designed to be able to reach any desired location of the biological tissues (31) that are placed upon the platform (27) at any angle, or depth. Various positions of the tissue interphase (25) can be achieved through the rotation of the ring (21), translation of the ring (21) and ring housing (30) along the length of the platform, and precise placement of articulated arm segments via its articulations. In a preferred embodiment, an articulated arm fixture (22) is also equipped with a Cam Housing (23) containing a cam that allows for logarithmic extension and retraction of a Tissue Interface (25) via the extension-retraction lever (24). These components allow a practitioner to apply and hold therapeutic levels of force upon biological tissues with minimal effort while still allowing for some level of physical feedback to the operator. Any other means of extension and retraction (24) that provide feedback and ease of use may also be utilized.

FIG. 1B shows arrows indicating the type of movement the ring will be capable of in a preferred embodiment of the apparatus. The ring (21), platform, 27, and ring housing (31) in a preferred embodiment may be outfitted with sensors and measuring equipment to detect and record the exact placement, angle, location of the various components, and fixtures in 3D space, enabling description of them in a manner, such as a coordinate system.

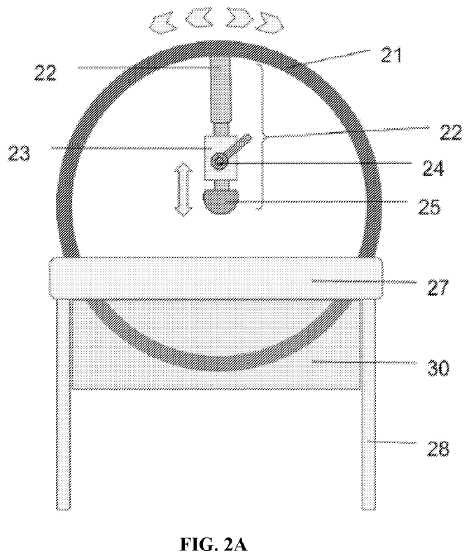

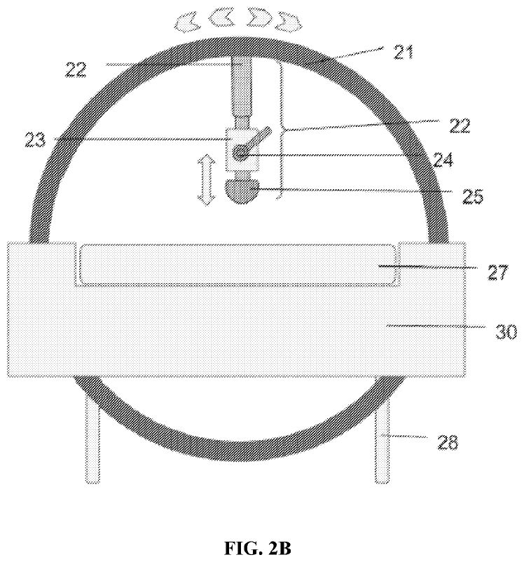

FIG. 2A shows a front facing view of the present invention with a transparent view of the Ring Housing (30) to better illustrate the ring (21) going through to the underside of the platform (27). It also shows the articulated arm fixture (22) comprising multiple parts such as telescoping segments, a cam housing (23), an extension-retraction lever (24) and a tissue interface (25).

FIG. 2A depicts a double sided arrow next to the articulated arm fixture (22) denoting the capacity for arm fixtures in a preferred embodiment to both extend and retract toward and away from tissues. Additionally, segments of an articulated arm fixture (22) may themselves extend and retract by utilizing lockable telescoping segments, threading, or other methods.

FIG. 2B shows an alternate embodiment of the ring system. The ring may be any size that suits the intended function and may exist within the platform and/or ring housing at any level or depth. The ring housing (30) may assume any shape and may also flank the sides of the platform (27), providing alternate ways of mounting the ring to the platform. In an alternate embodiment, it may be the case that the ring goes through only the housing and not the platform.

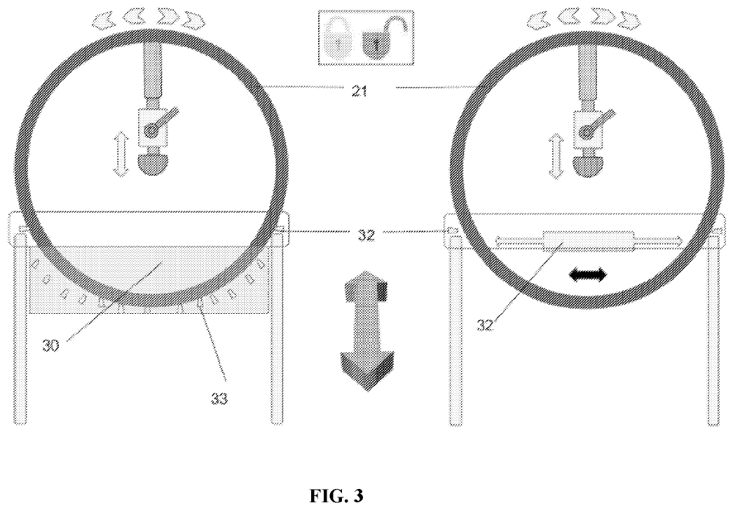

FIG. 3 shows means by which a ring (21) may move and also have its movement substantially stopped and locked in a preferred embodiment. The ring housing (30) may contain a Ring Housing Oriented Lock Mechanism (33) such as, but not limited to gears, nubs, or other locking technology. The Platform (27) itself may also contain Platform Oriented Locking Mechanisms (32) that may substantially stop movement of the ring via pressing gears or other locking technology upon or against the ring (21). The locking mechanisms (32,33) may be engaged and disengaged by a component such as a physical handle (29) on the ring housing (30) or by other computerized or electronic input mechanisms that correspond to a fluid workflow of a practitioner. In a preferred embodiment, the locking mechanisms (32,33) may be engaged and disengaged by other means, such as a pedal, or sensors on the ring (21) which can sense when a practitioner's hand is placed upon it. Locks may disengage while a hand is touching the ring, and relock as soon as the hand is no longer making contact with the ring (21). Other means of engaging and disengaging the locks may appear in other preferred embodiments.

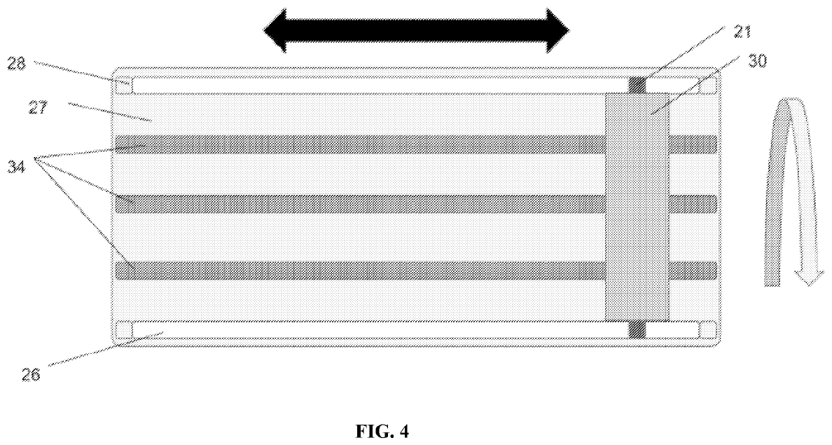

FIG. 4 shows a view from below the apparatus which gives a view of the Ring Housing Railing (34) that in a preferred embodiment keeps the ring and housing stabilized when moving them along the length of the platform. The railing (34) may consist of a number of different grooves, gears, or other features that allow it to easily lock and unlock the ring housing (30) so that it can remain in a fixed position when desired. The ring housing railing (34) may utilize additional technology to substantially stop movement of the housing and ring such as threads, magnets, brakes, or other suitable mechanisms.

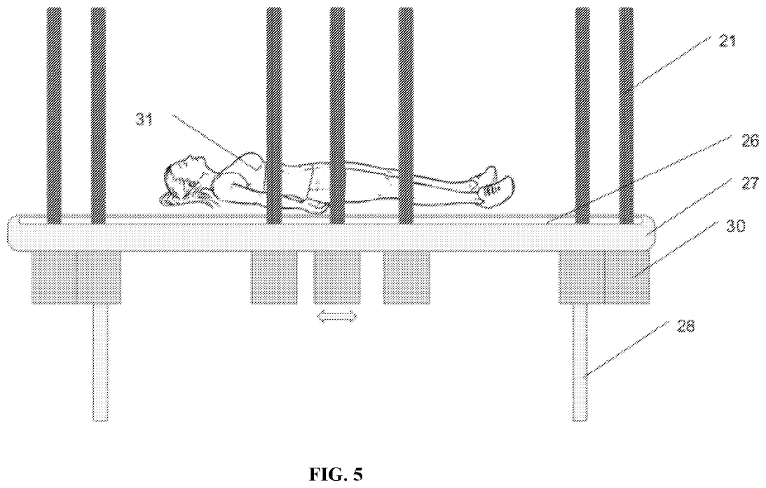

FIG. 5 shows a lateral view of the apparatus with multiple rings (21) and ring housings (30) installed to the platform (27). Furthermore, additional length may exist at the head and foot of the platform (27) to place or store a ring and its housing when not in use.

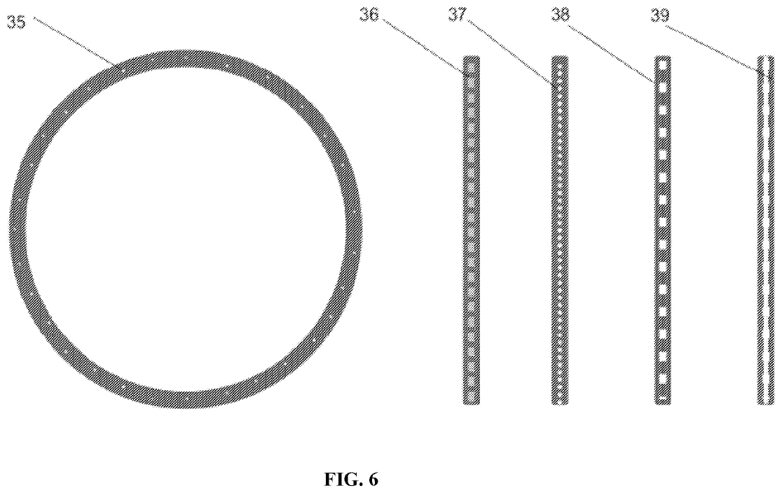

FIG. 6 shows various possible features of a ring from the front and side view in a preferred embodiment, primarily features that allow fixtures of all kinds to be attached. Ring-Face threaded Holes (35) in a preferred embodiment allow fixtures to be attached to the face of the ring. Inner ring threaded holes (37) allow fixtures, such as an articulated arm fixture, to be attached/mounted. Ring outside grooves (36) may in a preferred embodiment, be used to stop movement of the ring (21) inside the ring housing (30). Ring holes (38) may be utilized to place a bar or other support structure through the ring. A ring with a groove and slit aspect (39) may exist in some iterations of the preferred embodiment to allow a mounted fixture to slide within a section or sections of the ring itself. Such a ring with slits (39) would allow the ring to still rotate within its housing (30) while also allowing for translation of a fixture inside the slit of said ring.

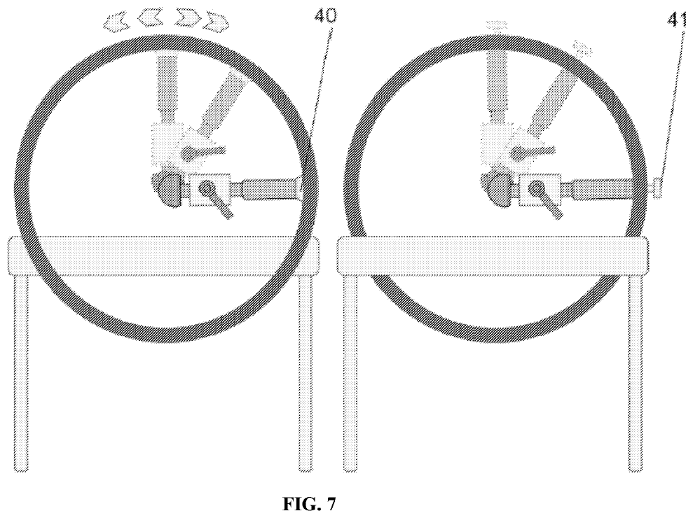

FIG. 7 shows the apparatus from a front facing view of an articulated arm fixture (22) and ring (21) rotating and changing position in the coronal plane, with both a Fixed Attachment Point (40) and a moveable/slidable Attachment Point (41). A fixed attachment (40) will consist of a fixture being solidly mounted to the ring while a moveable attachment (41) will allow some level of movement at the attachment point. Various combinations of these attachment types may be utilized via multiple ring types to achieve the desired effects. Fixed attachments (40) in a preferred embodiment may be immediately followed by an articulation such as a hinge joint or ball-and -socket joint allowing easy positioning of any fixture.

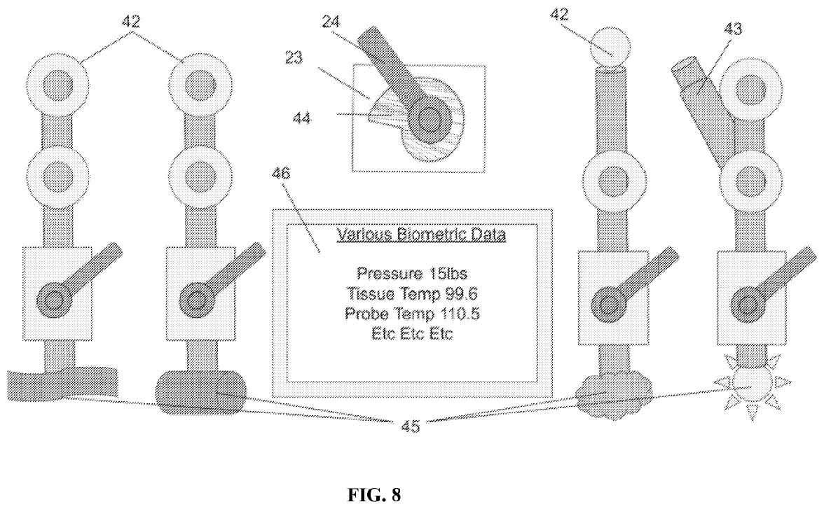

FIG. 8 shows a variety of articulated arms with lockable articulation types (42) which in a preferred embodiment consists primarily of hinge joints and ball-and-socket joints. Articulated arm fixtures (21) may consist of components such as but not limited to, arm segments, articulations, locking and unlocking joints, reinforcement segments (43), a cam housing (23), a Cam (44), extension-retraction lever (24), and various novel tissue interfaces (45). A cam housing, (23) may in another preferred embodiment, be replaced by a motorized method of extending and retracting a Treatment head/tissue interface (25) enabling percussive force and tissue engagement at varying therapeutic velocities. The extension-retraction (24) mechanism employed in a preferred embodiment will be minimally strenuous to the practitioner, capable of data gathering, and provide an extremely precise level of pressure to tissues as desired and deemed appropriate by the practitioner. All manner of shape and attribute may be utilized for a tissue interface and these attributes will be determined by the area and type of tissue it is to be used for/interfaced with. Novel tissue interfaces (45) may be highly customized in shape to best fit narrow, broad, or otherwise unique body tissues and segments in a suitable manner. A novel tissue interface (45) may also consist of nonhuman attributes such as heat, cold, radiation, ultrasound, vibration, or other therapeutic effects. Novel tissues interfaces (45) may be made of materials that mimic the feel and/or shape of natural body parts such as human hands. Various novel tissue interfaces (45) will in a preferred embodiment be capable of gathering data, such as tissue elasticity, tissue compliance, temperature, tonicity and other biometrics known or unknown. Additional biometrics gathered in a preferred embodiment can include, stiffness (Tonometer), Elasticity or kinetic storage capacity (Elastometer), and Pressure-pain sensitivity (Algometer). Various biometric data can be collected and displayed via a Biometric Data Display (46). While articulated arm fixtures (22) in a preferred embodiment are primarily mechanical and not outfitted with electrical components, they may also appear in alternative embodiments with various motorized end pieces as typified in massage tools or other tissue stimulation devices.

Said fixtures may be outfitted with electronic sensors to collect data, including but not limited to positional data of the articulations and their relative positions within a ring frame and interaction with tissues to be analyzed to find optimal tissue engagement strategies. Materials utilized for the various components, particularly tissue interfaces may range considerably and may include materials determined to be safe for use on biological tissues.

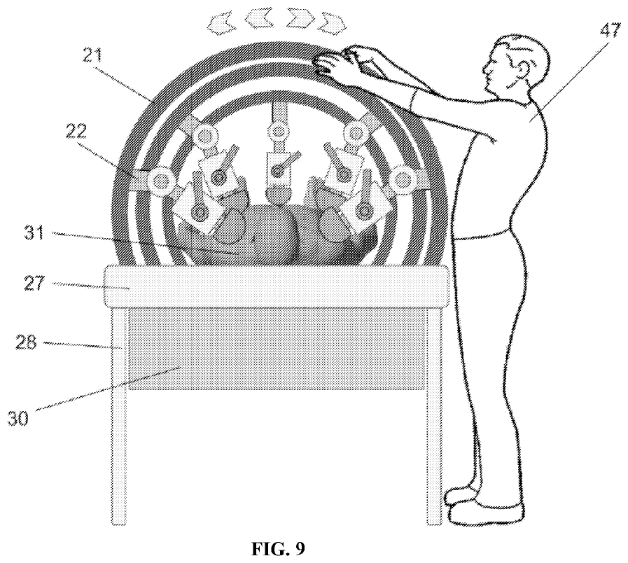

FIG. 9 shows a front facing view of the apparatus with numerous rings (21) and articulated arm fixtures (22) applied to biological tissues (31) in multiple positions, placed by an operator (47) to create a unique and desired tissue configuration. A practitioner or operator (47) and human subject (31) may engage with any desired level of personal protective equipment (PPE) including but not limited to masks, hazmat suits, face shields, goggles etc. when utilizing the device and may be further protected by having the additional distance afforded by utilization of the apparatus. Additionally, close proximity between practitioner and subject need not be maintained once a desired configuration is set, thus reducing opportunities for disease transmission during sessions. As an operator may in a preferred embodiment primarily impart force to biological tissues utilizing arm fixtures and other hardware, the typical closeness between subject and practitioners during manual therapy applications that may endanger both, when concern for pathogens is present, may be reduced or eliminated. While FIG. 9 may give the impression that an operator/practitioner work in a mostly hands off way, they may or may not be active with their natural appendages during work on the platform (27) by either supporting, lifting, moving, maneuvering, stretching or deforming the clients tissues in a manner consistent with traditional manual therapy manipulation, while the apparatus engages multiple areas at once in the background. Additionally, while the practitioner (47) may rely on the apparatus and rely upon data provided by the apparatus, traditional palpation will likely be utilized to ascertain which areas of tissue to engage with and determine the appropriate levels of force application to provide. The platform (27), legs (28), and ring housings (30) provide stability for numerous moveable/lockable components. A practitioner or operator (47) may work primarily in a standing orientation but may also adopt other positions including sitting as necessary and whatever other position allows easy access to fixtures and other components. Due to the rotational ability of the ring, fixtures on the opposite side of the platform from an operator (47) can be easily maneuvered back to the desired side of the platform (27) by rotation of the ring (21). Various fixtures may be attached to the rings (21) or other components to create a more ergonomic means of controlling them for a practitioner (47).

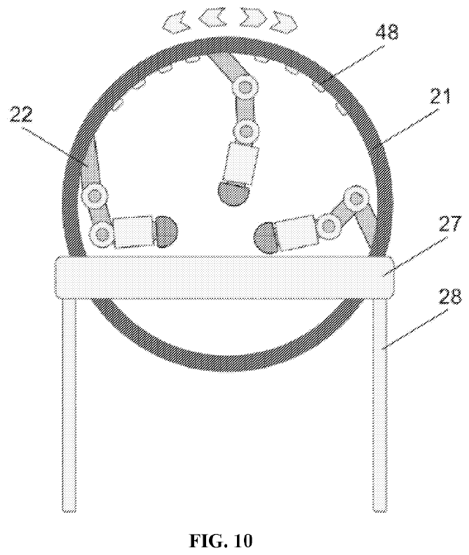

FIG. 10 shows a front facing view of multiple articulated arm fixtures (22) utilized in various positions some of which may help account for needed arm fixture length, to effectively lengthen and shorten arm segments by positioning them close to the ring or zig-zagging segments. With the utilization of telescoping segments, the length of a fixture may be adjusted.

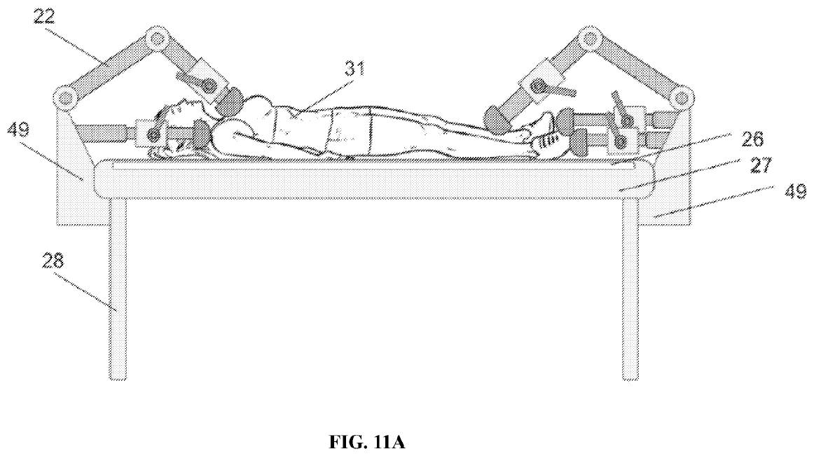

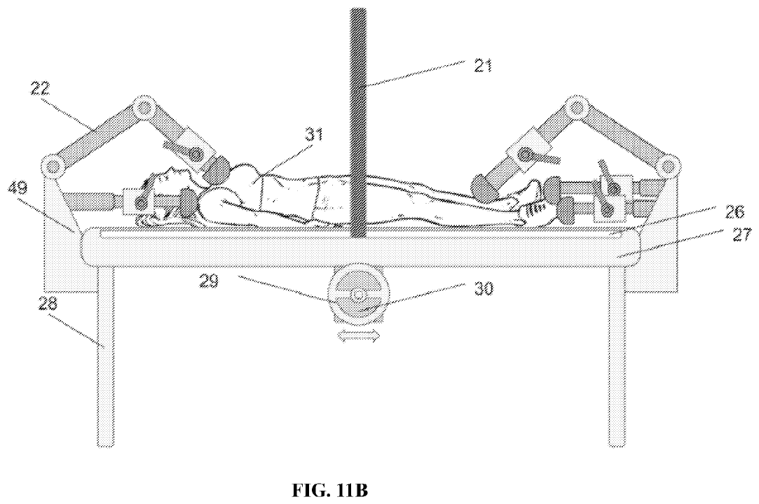

FIG. 11A shows a lateral view of the apparatus with an additional means of providing a mountable surface to affix repositionable fixtures. Two head/foot fixture boards (49) are connected at the head and foot of the table allowing a number of fixtures that can slide back and forth along the width of the platform (27). Such a placement of fixture boards (49) could appear anywhere along the ends of the platform where a different angle of approach and support may be required by a treatment fixture.

FIG. 11B shows the entire apparatus in a preferred embodiment with a fully realized system for gaining access to every point of biological tissues. While articulated arm fixtures (22) may have reach beyond the frame of the ring it is installed on, the most caudal and cephalad areas of the platform will likely be engaged best with an articulated arm fixture mounted on a head/foot fixture board (49) for the greatest mechanical advantage and stability. Such a fixture board (49) in a preferred embodiment may have the ability to be folded away or mounted and dismounted as required.

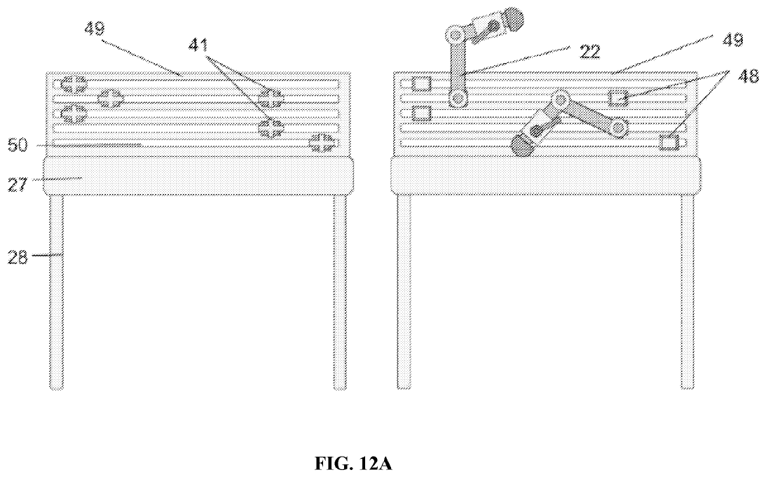

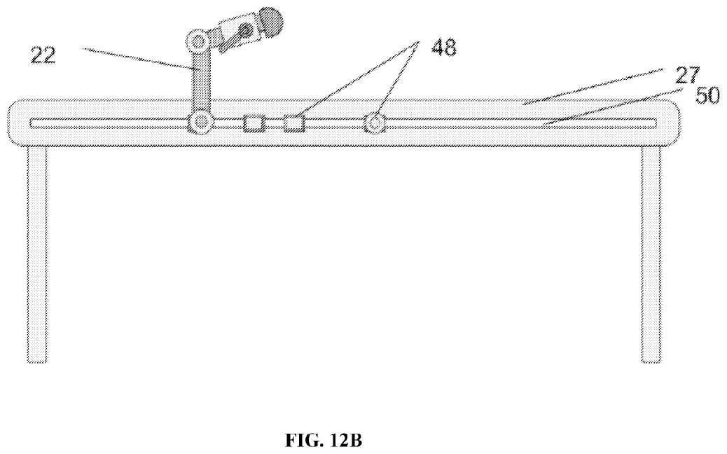

FIG. 12A shows a front and back facing view of the head/foot boards (49) with slidable general attachment points (48) allowing for smooth movement and locking of a fixture into position from one lateral side of the table to the other. Fixtures and mounted objects such as articulated arm fixtures (22) may slide along a general slit (50) that accommodates various attachment points (48).

FIG. 12B shows the platform (27) with an additional placement of a sliding slit (50) at the side of the table. This iteration may provide additional places for arms or other fixtures while not interfering with the board (49), rings (21) and/or ring housings (30).

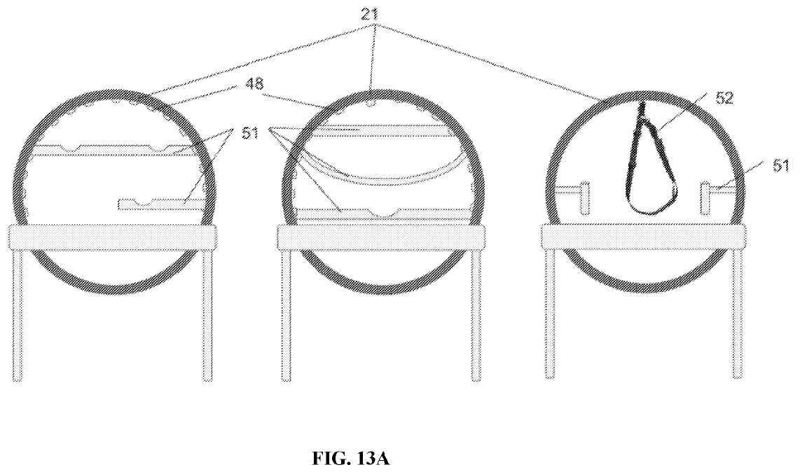

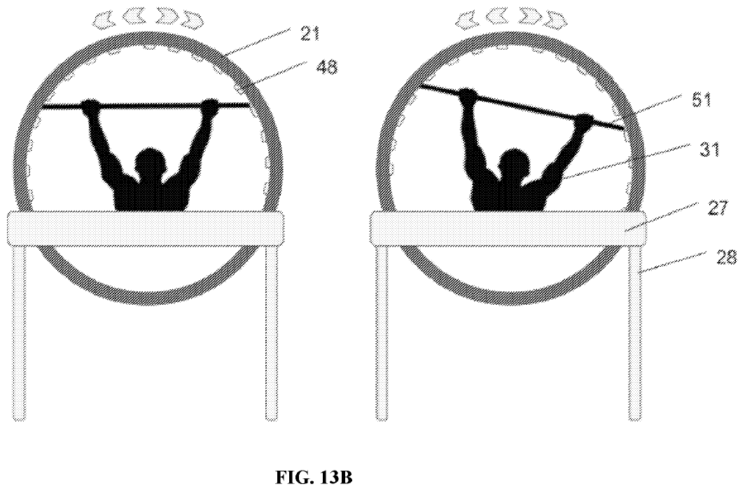

FIG. 13A shows a front facing view of multiple platforms and ring systems with general attachment points (48), as well as, various support fixtures (51) that may provide rotatable/moveable structures that can support body parts or provide support for additional fixtures. Various support structures (51) serve to allow a body part or segment to be placed in numerous positions or held in positions to better gain access to other body areas and anatomically defined tissues. A support may consist of elements such as, but not limited to, handles, bars, hoops, trays, etc. A support structure (51) may be placed at any area of the body requiring said support and may have any shape, material, structure, or padding (etc.) necessary to obtain the desired level of comfort for the biological tissues (31) being configured. A support (51) may also serve as an attachment point for any other treatment fixtures and may also have general slits in them to allow translation of a fixture along the slit (as shown in previous figures such as FIG. 12A & 12B). Various attachments (52) such as slings, ropes, resistance bands, cables and other such attachments may be employed to produce other configurations of tissues. Support bars and cuffs and limb or body part rests will allow practitioners to precisely hold and position a body part to allow ease of access to desired tissues. Support of various body parts allow for various tissues to be set to a desired tension level, slacken, stretch and/or tonify tissues. Various support fixtures (51) in a preferred embodiment can be easily set up to a desired position.

FIG. 13B shows a front facing view of the apparatus with a human being consisting of living biological tissues (31) engaging a support fixture (51) to perform a novel set of muscles contractions in both a neutral(horizontal) and angled (diagonal) position. The use of various support structures allows for both passive and active engagement with said fixtures. Rotation of various fixtures via the ring (21) may allow activation, stretch, deformation and other therapeutic dynamics to occur at areas of the body that may otherwise not occur when performing the same exercise in a traditional fashion. Various contraction types may be utilized including isometric, concentric, eccentric and others in any combination.

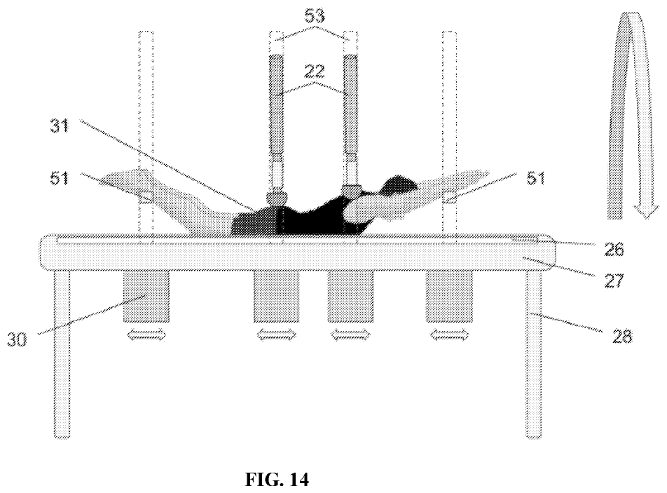

FIG. 14 shows a lateral view and compound function of the apparatus, utilizing the support, deformation, and muscle activation aspects of the disclosed technology. Shown is a human subject (31) laying prone upon the platform with arms and legs placed upon various support structures (51) housed and locked within a transparent view of the rings (53), while two articulated arms (22), also shown in a transparent view of rings (53), engage and deform tissues of the back and glutes at a desired level of force. A human subject (31) may also engage or relax various contractile tissues purposefully, voluntarily or be made to contract involuntarily by external means such as a TENS unit while in a configuration.

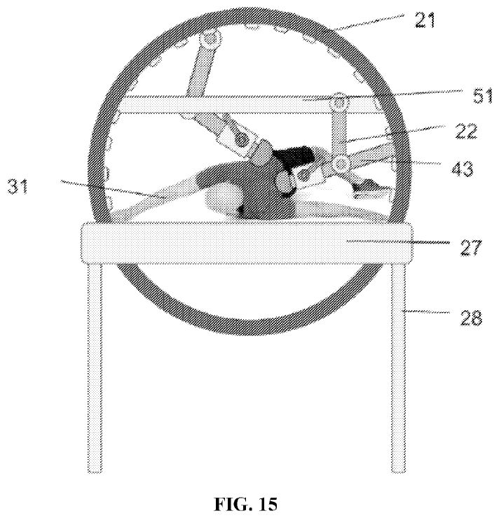

FIG. 15 shows a front facing view of another possible positioning of biological tissues, with a ring (21) with articulated arm fixtures mounted directly to the ring and also to another support structure (51) set within the ring. One articulated arm fixture (22) utilizes a reinforcement segment (43) that may allow said arm to withstand greater levels of force when necessary.

Reinforcement segments (43) in a preferred embodiment may be used in a myriad of ways and one may employ as many segments as necessary to withstand the required force. FIG. 15 again shows a novel configuration of biological tissues utilizing the apparatus' inherent components to hold, deform, support, and stretch said tissues. The entire apparatus facilitates the movement, positioning and configuration of the subject's tissues (31) in active and passive interactions.

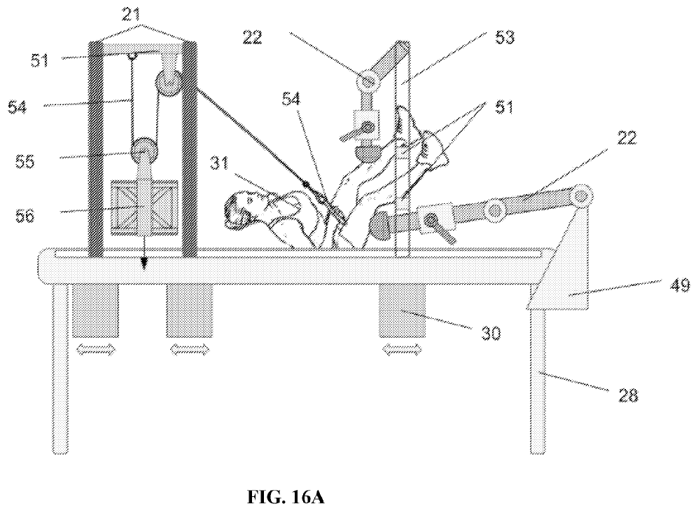

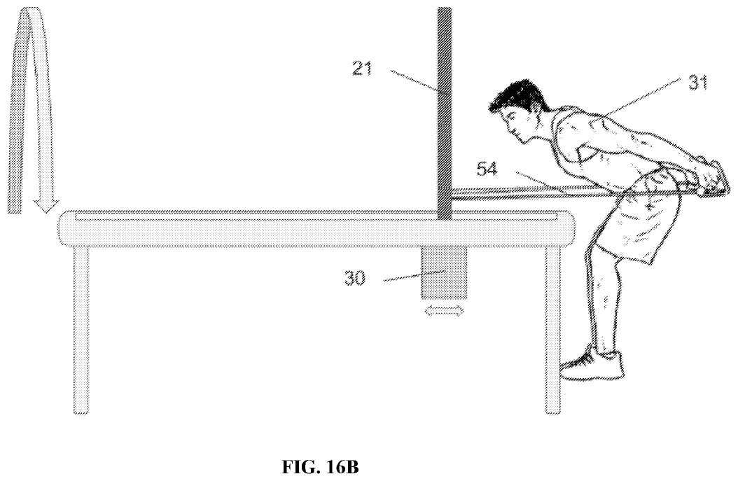

FIG. 16A shows a lateral view of the apparatus depicting another compound usage of the platform (27) with rings (21 & 53) mounted with arms (22) and support fixtures (51) in combination with a weighted cable or resistance band (54), pulley system (55) and variable weight (56) allowing for a more challenging interaction for a human subject whilst other body areas are supported (51) and worked upon/configured by articulated arm fixtures (22). Any manner of tissue configuration both externally and internally may be achieved through the utilization of these various components to support, deform, stretch, and exercise tissues in any direction in 3d space, in any combination. A therapeutic rationale may be made for such a configuration such as a neurodynamic rationale that considers movement or nerves through various tissues, whose various mechanical considerations may require extremely novel, asymmetrical and other creative configurations to affect tissues. Contraction types such as concentric, eccentric, isometric and others may be utilized at various contractile tissue sites voluntarily or involuntarily to facilitate the internal and external configurations desired by the practitioners or subject.

FIG. 16B shows an alternate method of interacting with the apparatus (21,30) with a human subject (31) utilizing a resistance band (54) attached/affixed to an element on of the ring (21) or the ring itself. FIG. 16B also shows a human subject (31) may interact with the apparatus on or off the platform and in various positions in space around the platform.

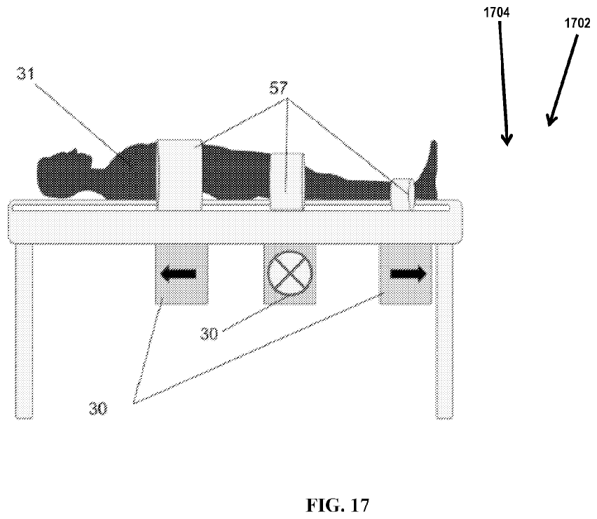

FIG. 17 shows a lateral view of the apparatus with an alternate use for the ring housing (30) as a housing for a strap (57) for example, or other continuous object that allows biological tissues to be held firmly in place against the platform and/or be tractioned in opposing directions as deemed necessary by an operator or therapist. Other fixtures may also traction and pull various tissues in opposing directions. Straps (57) in a preferred embodiment may be secured in as loose or tight a manner, as required and may have their slackness set by mechanisms within the housing (30). Straps (57) or other mechanisms may be utilized to securely fasten biological tissues to the platform, especially when altering the orientation of tissues in gravity/a gravitational field.

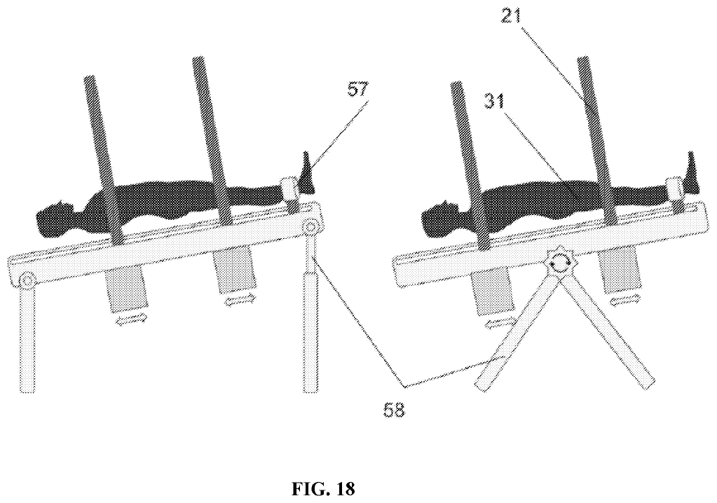

FIG. 18 shows a lateral view of the platform with a human subject being capable of changing its orientation in gravity by utilizing a tilt capable leg system (58). In the case of tilting the platform, a strap (57) or other securing element could be utilized to prevent slippage of biological tissues from the platform. The platform (27) utilizing a tilt capable leg system (58) in a preferred embodiment will be able to tilt at any slope or angle mechanically possible.

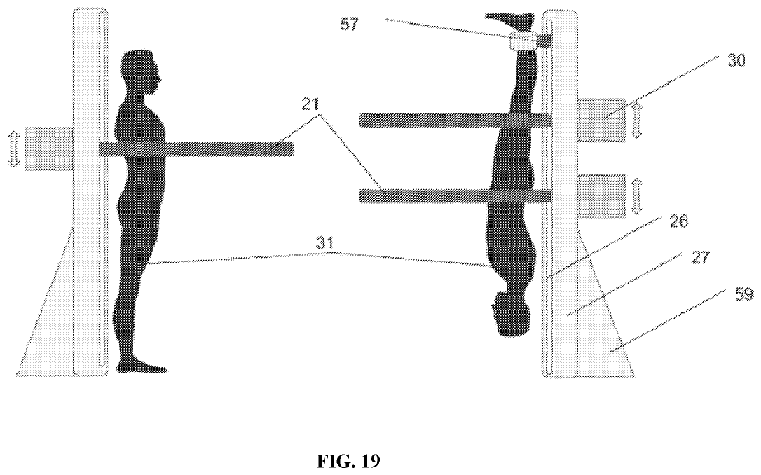

FIG. 19 shows a lateral view of the apparatus in a vertical arrangement, depicting the use of the invention in both a standing or upside down position with a platform stand (59) stabilizing the invention in this position. As the intended function of the apparatus is to configure and deform tissues into any conceivable combination, the direction of gravity acting upon various tissue structures is an essential consideration to allow for more nuanced, novel, and facilitated interventions. The various components outlined provide accommodations for said interventions. A strap (57) or series of securing elements could hold biological tissues in an unconventional or novel position for the purposes of relieving or altering pressure within tissues. Any therapeutic distortion/deformation may be achieved with minimal effort through the utilization of gravity to alter the configuration of tissues.

FIG. 20 shows a front view of the apparatus with Various Lighting/Imaging Systems (60) installed within the ring (21) frame. A primary function of the Tissue Configuration Platform is to also collect data about various configuration relationships and force transmission and deformation data across time in numerous subjects. 3D mapping, infrared, body topography, ultrasound, and all other data that can be collected, will be. The ring provides a novel housing for said technology and may also provide support for various kinds of lights utilized for therapeutic purposes such as, but not limited to, red light, ultraviolet, etc. Biological tissues (31) may be outfitted with suits, motion trackers, wearables and other data providing technology to ascertain as many quantifiable parameters and biometrics as possible and as necessary. Such data may be incorporated into software and other systems such as, but not limited to, a coordinate system.

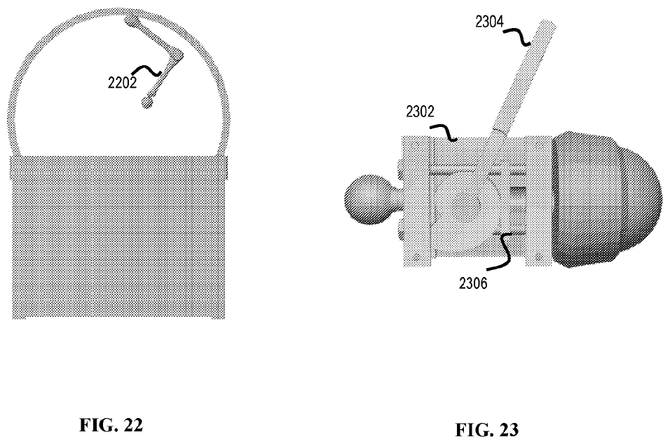

FIG. 22 shows an example of an extension attachment 2202 having two joints. The joint closer to the covering attachment may be used to position along head-foot direction and extend radially to be as close to the platform as needed, while the farther joint may be used for finer placement of the tip (.e.g., a sensor or a therapeutic tip) near target tissue.

FIG. 23 shows an example of a cam box mechanism with handle in unextended position. The cam box includes a chamber 2302 that houses a shell-like structure of increasing radius placed in close proximity of a member 2306 for a piston-like action to exert a force on a tissue-side tip. As the handle 2304 is rotated by a practitioner, the radius of the shell-like structure pushing against the member 2306 correspondingly causing the member 2306 to move outward or inward. In some embodiments, the member 2306 may be spring loaded so as to restore its inward position when no force is applied.

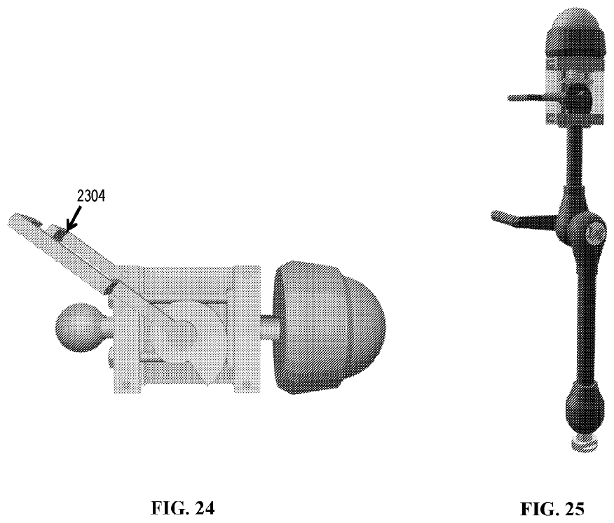

FIG. 24 shows an example of a cam box mechanism with handle in extended position such that the handle 2304 has been rotated to cause wider radius of the shell-like structure to push the member 2306 outward.

FIG. 25 shows an example of an extension attachment having two handles for simultaneous manipulation. In this example, the cam chamber is located at the top, with the spring that loads the sensor tip to be in a certain position when no force is applied from the handle is visible. The middle of this extension attachment includes a handle that can be grasped by a practitioner for positioning and removal of the extension attachment. The handle may also serve the function of locking the joint during use.

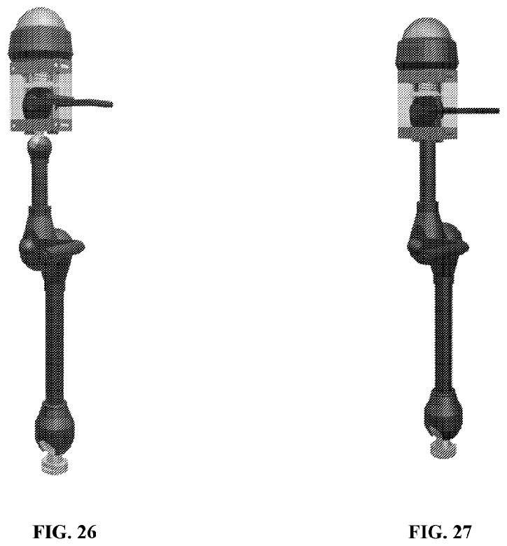

FIG. 26 shows another example of an extension attachment having two handles for simultaneous manipulation. This elevation view is shown from opposite side of the elevation view depicted in FIG. 25, making the handle visible.

FIG. 27 shows another example of an extension attachment having two handles for simultaneous manipulation.

FIG. 28 shows another example of an extension attachment having two handles for simultaneous manipulation. In this view, the extension attachment is shown to have been bent in the lower joint, e.g., for adjusting radial length thereof.

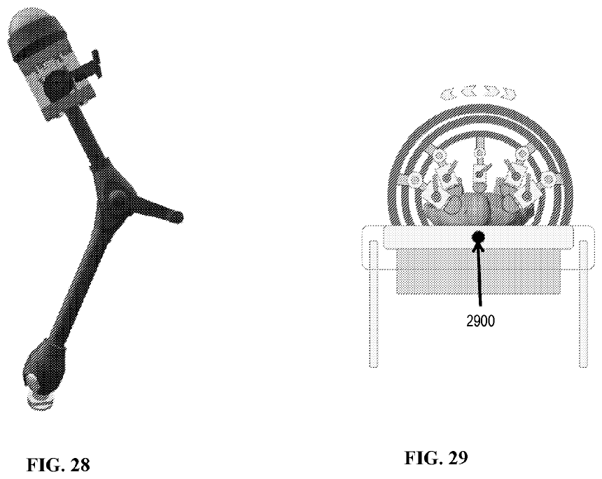

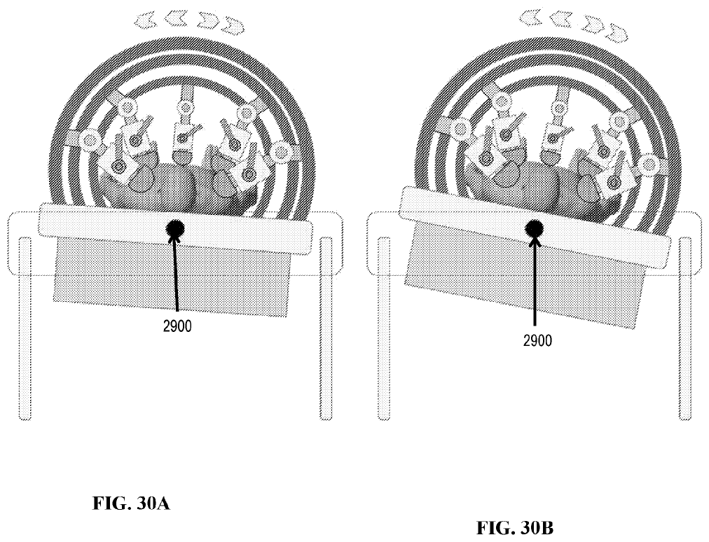

FIGS. 29 and 30A-30B show a tissue manipulation apparatus inside a housing that allows for axial tilting of the platform. Here, axial tilting refers to the center axis of a human body that may be a target subject lying on the platform during use of the tissue manipulation apparatus.

FIG. 29 is a side elevation view of a tissue manipulation apparatus. A sideways tilting control knob 2900 is depicted at the headboard side of the platform. A practitioner may be able to rotate this knob in a clockwise or an anti-clockwise direction to cause the subject to rotate along the center axis (length of the body) such that either the left side goes below the right side of the body or vice versa.

FIGS. 30A-30B depict tilting aspects of a tissue manipulation apparatus. Here, FIG. 30A shows the human subject being tilted slightly in the right direction. FIG. 30B shows increased tilting that may be achieved by further clockwise rotation of the tilting control knob 2900. In some embodiments, the tilting control knob 2900 may be available both at the headboard and the footboard to avoid the practitioner having to walk over to one side to achieve the tilting.

The following listed items may represent some embodiments of the disclosed techniques.

1. A system for tissue configuration, comprising: a frame comprising a planar surface comprising a platform defined by a left edge, a right edge, a head edge and a foot edge, and one or more covering attachments, wherein each covering attachment include a first region at which the covering attachment is coupled to the left edge and a second region of the covering attachment coupled to the right edge, the covering attachment further including a body portion that spans between the first region and the second region over the planar surface forming an opening between the body of the covering attachment and the planar surface; wherein the body of at least some of the covering attachment includes a first side oriented towards the planar surface, the first side comprising one or more attachment points having one or more base units to which one or more extension attachments extending towards the planar surface are attachable. Examples of the frame are depicted throughout the present application, including FIGS. 1-5, 7, and 9-20.

2. The system of item 1, wherein the one or more covering attachments include a ring that includes the body and a second portion extending below the planar surface upon coupling the ring to the platform. Various embodiments of rings are described with respect to FIGS. 2A, 2B, 3, 4, 7, 10, 13A, 13B, 14, etc.

3. The system of item 2, wherein the ring is coupled to the platform such that the ring is fully rotatable arounds a center axis of the ring. See, for example, description of FIGS. 1 to 10.

4. The system of any of items 1-3, wherein the planar surface is a rectangular surface.

5. The system of any of items 1-3, wherein the frame comprises a ring housing within which the platform is positioned, and wherein the planar surface comprises the platform and a top surface of the ring housing, and wherein the ring is coupled to the ring housing. FIG. 1A, 1B and 2B, for example, show some example embodiments.

6. The system of any of items 1-3, wherein the frame is mounted on a support structure that comprises four legs extending downwards from four corners of the frame. Alternatively, the frame may be made of a flat bottom, allowing direct placement of the frame on floor. Such embodiments will enable use without a need to have target subject mount or climb up the frame.

7. The system of item 2, wherein the one or more covering attachments include multiple rings that are spaced apart from each other along the left edge and the right edge.

8. The system of any of items 1-7, wherein the one or more base units comprise threaded holes through the first side of the covering attachments. FIG. 6, for example, shows some example embodiments.

9. The system of any of items 1-7, wherein the one or more base units are placed inside a groove along the first side, allowing the one or more extension attachments to rotate along the groove along a length of the body. For example, FIG. 4 shows some embodiments.

10. The system of item 8, wherein the threaded holes through the first side open on an outside of the covering attachments enabling positioning of an arm fixture into the threaded hole, wherein the arm fixture is securely affixable to the covering attachments with a screw from the second side.

11. The system of item 10, wherein the arm fixture is an articulated arm fixture having a fixed portion that is solidly mountable to the covering attachments, and a moveable portion coupled to the fixed portion through a rotatable joint that allows for a rotational movement of the moveable portion at an angle from the fixed portion.

12. The system of item 11, wherein the rotatable joint is a hinge joint or a ball and socket joint. Some examples are described, e.g., with respect to FIG. 8.

13. The system of any of items 11-12, wherein the articulated arm fixture includes one or more of a locking joint, an unlocking joint, a reinforcement segment, a cam housing, a cam, an extension retraction lever, a telescopically extending member, or a tissue interface.

14. The system of any of items 11-13, wherein a farthest tip of the articulated arm fixture that is away from the fixed portion is configured with sensors or tissue simulators. Some examples are described, e.g., with respect to FIG. 8.

15. The system of any of items 1-14, wherein the head edge comprises a headboard affixed to the head edge having base portions on which additional arm fixtures are mountable. FIG. 12A and 12B show some examples of such embodiments.

16. The system of items 1-15, wherein the foot edge comprises a footboard affixed to the foot edge having base portions on which additional arm fixtures are mountable. FIG. 12A and 12B show some examples of such embodiments.

17. The system of item 15, wherein the base portions of the headboard are positioned in one or more groove that allows the base portions to slide along lengths of the one or more grooves. FIG. 12A and 12B show some examples of such embodiments.

18. The system of item 16, wherein the base portions of the foot board are positioned in one or more groove that allows the base portions to slide along lengths of the one or more grooves. FIG. 12A and 12B show some examples of such embodiments.

19. The system of any of items 1-18, wherein the one or more extension attachments include an articulated arm, a handle, a bar, a hoop or a tray. Various examples are depicted and described with reference to FIGS. 13A, 13B, 16A, 16B.

20. The system of any of items 1-19, wherein the one or more extension attachments include a bar such that two ends of the bar are attached to two base units. Various examples are depicted and described with reference to FIGS. 13A, 13B, 16A, 16B.

21. The system of any of items 1-20, wherein the one or more covering attachments include a strap having an adjustable length that allows securely holding an object on the platform. Some example embodiments are described with reference to FIG. 17.

22. The system of item 21, wherein the strap is mounted on a housing that is slideable along a length of the platform. Some example embodiments are described with reference to FIG. 17.

23. The system of any of items 1-22, wherein the support structure is adjustable such that the frame is tilted to a desired angle, causing the platform to tilt at the desired angle with respect to a horizontal direction. Some example embodiments are described with reference to FIG. 18, 19.

24. The system of item 23, wherein the desired angle is 90 degrees such that the frame is in a vertical position. Some example embodiments are described with reference to FIG. 18, 19.

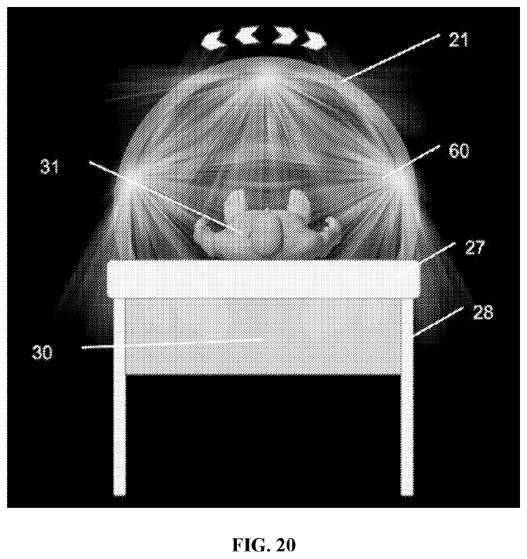

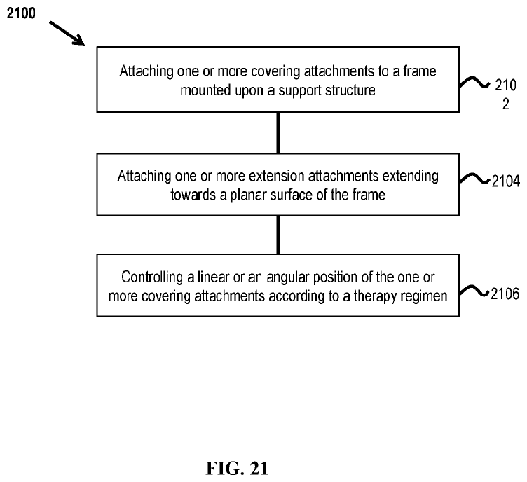

25. A method of tissue manipulation (e.g., method 2100 depicted in FIG. 21), includes attaching (2102) one or more covering attachments to a frame mounted upon a support structure, wherein the frame comprises a planar surface comprising a platform defined by a left edge, a right edge, a head edge and a foot edge. As described with respect to FIGS. 1 to 20, each covering attachment may include a first region at which the covering attachment is coupled to the left edge and a second region of the covering attachment coupled to the right edge. In some embodiments, the covering attachment further including a body portion that spans between the first region and the second region over the planar surface forming an opening between the body of the covering attachment and the planar surface. The body of at least some of the covering attachments includes a first side oriented towards the planar surface, the first side comprising one or more attachment points having one or more base units.

The method 2100 further includes attaching (2104) one or more extension attachments extending towards the planar surface such that a distal tip of the one or more extension attachments is in close contact with a target object on the planar surface. The attachment may be performed, for example, by a practitioner or a manufacturer of the equipment to customize the use of the tissue configuration apparatus for a specific regimen.

The method 2100 further includes controlling (2106) a linear and/or an angular position of the one or more covering attachment according to a therapy regimen. Various ways by which the platform may be used for tissue configuration are depicted and described with respect to FIGS. 1 to 20 and 22 to 28.

26. The method of item 25, wherein the one or more extension attachments includes a sensor attachment having the distal tip configured to collect data from the target object, and wherein the method further includes: controlling the one or more extension attachment to collect and transmit the data to a controller communicatively coupled to the frame.

27. The method of any of items 25-26, wherein the one or more covering attachments include multiple covering attachments and the method further includes: adjusting lateral positions of the multiple coverings to align with a corresponding part of the target object according to the therapy regiment.

28. The method of any of items 25-27, further including: attaching an extension attachment to a headboard at the head edge or a baseboard at the base edge.

29. An arm fixture, comprising: an elongated body having a first end affixable to an attachment point and a second end to which a tissue interface is attachable, the elongated body comprising multiple segments coupled to each other through joints, and an extension-retraction lever coupled to a segment of the multiple segments, wherein the extension-retraction level includes a cam element located within a cam housing such that a rotational movement of the extension-retraction lever causes the cam element to rotate within the cam housing, thereby causing the segment to move along a direction, the extension-retraction level being lockable at various angles with respect to the segment. Various examples of arm fixtures are described with reference to attachable extensions throughout the present document, including with reference to FIGS. 2A to 12B, 15, and 22 to 28.

30. The arm fixture of item 29, wherein the joints include a hinge joint or a ball-and-socket joint.

31. The arm fixture of any of items 29-30, wherein the tissue interface comprises a tissue interface configured to apply a percussive force by engaging with an object.

32. The arm fixture of any of items 29-30, wherein the tissue interface comprises a tissue interface configured to apply heat to an object.

33. The arm fixture of any of items 29-30, wherein the tissue interface comprises a tissue interface configured to emit ultrasound waves towards an object.

34. The arm fixture of any of items 29-33, wherein the tissue interface includes a sensor configured to gather data including at least one of a tissue elasticity, tissue compliance, temperature, tonicity, stiffness, elastic or kinetic storage capacity, or pressure-pain sensitivity.

In some embodiments, a method of manufacturing tissue configuration equipment may include providing a frame that includes a planar surface defined by a platform on which a subject may lie down. The method of manufacturing may further include providing a left edge, a right edge, a head edge and a foot edge to the platform, as described in the items 1-34 above.

In some embodiments, another method of manufacturing may including fabrication of covering attachments such as arm fixtured that are described and depicted throughout the patent document, including, e.g., FIGS. 22 to 30. For example, this method may include assembling an arm fixture as described and depicted in FIGS. 25 to 27. The method may include assembling the various segments of the arm fixture, attaching a sensor tip and the cam chamber to the arm fixture. The method may further include manufacturing additional attachments that may be used as replacements appropriate to a specific use of the arm fixture (see, e.g., FIG. 8).

It will be appreciated that a versatile tissue configuration platform is disclosed. The tissue configuration platform will allow for numerous inputs, forces, supports, deformations and other configuration opportunities to occur to biological tissues on the platform, while allowing for an unprecedented amount of nuance, control, and sustainability with regards to achieving them. Primarily conceived as a force application device for use on multiple points simultaneously, the apparatus, through its flexible positioning system, allows for many other functions and combinations of functions, some that have been imagined and others not yet imagined.

1. A system for tissue configuration, comprising:
a frame comprising a planar surface comprising a platform defined by a left edge, a right edge, a head edge and a foot edge, and
one or more covering attachments, wherein each covering attachment include a first region at which the covering attachment is coupled to the left edge and a second region of the covering attachment coupled to the right edge, the covering attachment further including a body portion that spans between the first region and the second region over the planar surface forming an opening between the body of the covering attachment and the planar surface;
wherein the body of at least some of the covering attachment includes a first side oriented towards the planar surface, the first side comprising one or more attachment points having one or more base units to which one or more extension attachments extending towards the planar surface are attachable.

2. The system of claim 1, wherein the one or more covering attachments include a ring that includes the body and a second portion extending below the planar surface upon coupling the ring to the platform.

3. The system of claim 2, wherein the ring is coupled to the platform such that the ring is fully rotatable arounds a center axis of the ring.

4. (canceled)

5. The system of claim 1, wherein the frame comprises a ring housing within which the platform is positioned, and wherein the planar surface comprises the platform and a top surface of the ring housing, and wherein the ring is coupled to the ring housing.

6. The system of claim 1, wherein the frame is mounted on a support structure that comprises four legs extending downwards from four corners of the frame.

7. The system of claim 2, wherein the one or more covering attachments include multiple rings that are spaced apart from each other along the left edge and the right edge.

8. The system of claim 1, wherein the one or more base units comprise threaded holes through the first side of the covering attachments.

9. The system of claim 1, wherein the one or more base units are placed inside a groove along the first side, allowing the one or more extension attachments to rotate along the groove along a length of the body.

10. The system of claim 8, wherein the threaded holes through the first side open on an outside of the covering attachments enabling positioning of an arm fixture into the threaded hole, wherein the arm fixture is securely affixable to the covering attachments with a screw from the second side.

11. The system of claim 10, wherein the arm fixture is an articulated arm fixture having a fixed portion that is solidly mountable to the covering attachments, and a moveable portion coupled to the fixed portion through a rotatable joint that allows for a rotational movement of the moveable portion at an angle from the fixed portion.

12-14. (canceled)

15. The system of claim 1, wherein the head edge comprises a headboard affixed to the head edge having base portions on which additional arm fixtures are mountable; and
wherein the foot edge comprises a footboard affixed to the foot edge having base portions on which additional arm fixtures are mountable.

16. (canceled)

17. The system of claim 15, wherein the base portions of the headboard are positioned in one or more groove that allows the base portions to slide along lengths of the one or more grooves.

18. (canceled)

19. The system of claim 1, wherein the one or more extension attachments include an articulated arm, a handle, a bar, a hoop or a tray.

20. The system of claim 1, wherein the one or more extension attachments include a bar such that two ends of the bar are attached to two base units.

21. The system of claim 1, wherein the one or more covering attachments include a strap having an adjustable length that allows securely holding an object on the platform.

22. (canceled)

23. The system of claim 1, wherein a support structure is adjustable such that the frame is tilted to a desired angle, causing the platform to tilt at the desired angle with respect to a horizontal direction.

24. (canceled)

25. A method of tissue manipulation, comprising:
attaching one or more covering attachments to a frame mounted upon a support structure, wherein the frame comprises a planar surface comprising a platform defined by a left edge, a right edge, a head edge and a foot edge,
wherein each covering attachment include a first region at which the covering attachment is coupled to the left edge and a second region of the covering attachment coupled to the right edge, the covering attachment further including a body portion that spans between the first region and the second region over the planar surface forming an opening between the body of the covering attachment and the planar surface;
wherein the body of at least some of the covering attachments includes a first side oriented towards the planar surface, the first side comprising one or more attachment points having one or more base units;
attaching one or more extension attachments extending towards the planar surface such that a distal tip of the one or more extension attachments is in close contact with a target object on the planar surface; and
controlling a linear and/or an angular position of the one or more covering attachment according to a therapy regimen.

26. The method of claim 25, wherein the one or more extension attachments includes a sensor attachment having the distal tip configured to collect data from the target object, and wherein the method further includes:
controlling the one or more extension attachment to collect and transmit the data to a controller communicatively coupled to the frame.

27-28. (canceled)

29. An arm fixture, comprising:
an elongated body having a first end affixable to an attachment point and a second end to which a tissue interface is attachable, the elongated body comprising multiple segments coupled to each other through joints, and
an extension-retraction lever coupled to a segment of the multiple segments, wherein the extension-retraction level includes a cam element located within a cam housing such that a rotational movement of the extension-retraction lever causes the cam element to rotate within the cam housing, thereby causing the segment to move along a direction, the extension-retraction level being lockable at various angles with respect to the segment.

30. (canceled)

31. The arm fixture of claim 29, wherein the tissue interface comprises:
a tissue interface configured to apply a percussive force by engaging with an object; or
a tissue interface configured to apply heat to an object; or
a tissue interface configured to emit ultrasound waves towards an object.

32-35. (canceled)
